(19) United States
(12) Patent Application Publication
(10) Pub. No.: US 2012/0204225 A1
(43) Pub. Date: Aug. 9, 2012

(54) ONLINE AUTHENTICATION USING AUDIO, IMAGE AND/OR VIDEO

(75) Inventor: Ram COHEN, Tel Aviv (IL)

(73) Assignee: ACTIVEPATH LTD., Petah-Tiqva (IL)

(21) Appl. No.: 13/367,592

(22) Filed: Feb. 7, 2012

Related U.S. Application Data
(60) Provisional application No. 61/440,401, filed on Feb. 8, 2011.

(51) Int. Cl. G06F 21/00

(52) U.S. Cl. 726/3

(57) ABSTRACT

Systems, methods, and computer program products for online authentication using audio, video and/or image data. In some examples, audio, video and/or image data of a user may be captured, and recognition may be performed on at least part of the captured data during an attempt to confirm that the user is who he/she is supposed to be. If the attempt is successful, a validation confirmation may be generated. In some cases of these examples, the validation confirmation or a part thereof may optionally be provided to a server during user authentication relating to a resource provided by the server. Additionally or alternatively, in some cases of these examples, at least part of the captured data may optionally be provided to the server during user authentication. Depending on the example, the server may or may not be a web server.

### CROSS REFERENCE TO RELATED APPLICATIONS

This application claims the benefit of U.S. Provisional No. 61/440,401, filed Feb. 8, 2011, which is hereby incorporated by reference herein.

### TECHNICAL FIELD

The presently disclosed subject matter relates to the field of online authentication.

### BACKGROUND

Users are required to authenticate for various online operations such as when logging on to a web site, performing a financial transaction, opening a secure message, etc.

Online authentication has become a target of attack in order to steal user credentials. Some of the attacks employ a client side malicious component (e.g. man in the browser) that compromises the web browser by attaching itself to the web browser and monitoring the browser and/or user activity, including for example the user keystrokes.

To combat these attacks, various methods have been introduced including what is commonly known as a “second factor” which is an additional piece of information required to authenticate the user apart from the user password. Examples of such second authentication factors are a hardware token, sending an SMS message with a one-time additional password, a fingerprint, etc.

### SUMMARY

In one aspect, the disclosed subject matter provides a system for online user authentication using audio, video and/or image data, comprising: a client operable to attempt to gain access to a resource provided by a server for which there is a requirement for authentication of a user of the client; an input operable to capture audio, video and/or image data of the user; and a validator operable to transmit at least part of the captured audio, video and/or image data to a validation system, thereby enabling the validation system to generate a validation confirmation if identity of the user is confirmed at least partly based on at least part of the transmitted data.

In some embodiments, the system is further operable to receive at least part of the validation confirmation from the validation system, and to transmit at least part of the validation confirmation to the server.

In some embodiments, the system is further operable to transmit at least part of the captured data to the server during authentication.

In some embodiments of the system, the captured data includes audio and/or video data captured while the user says a text.

In some of these embodiments, the text and the captured data are supposed to refer correctly to the authentication requirement so that if the text or the captured data does not refer correctly to the requirement, then it is possible that the text or the captured data has been tampered with.

In some of these embodiments, the text does not have to refer to the authentication requirement.

In some embodiments, the system is further operable to receive at least one direction relating to capturing audio, video and/or image data of the user from the validation system.

In some embodiments of the system, the captured data includes at least one of the following captured for the user: an action, a gesture, or a facial expression.

In some embodiments, the client is a web browser or other application operable to attempt to access a resource provided by a web server, and the server is a web server.

In some embodiments of the system, the validator is included in the client.

In some embodiments of the system, the validator is external to the client.

In some embodiments, the system further comprises: a validation system operable to generate a validation confirmation if identity of the user is confirmed to be proven at least partly based on at least part of the transmitted data.

In some embodiments, the system further comprises: a server operable to allow access to the resource at least partly based on the validation confirmation or a part thereof.

In some embodiments, the system is at least one user device, and if necessary further comprises additional hardware, software, firmware or a combination thereof which enables the system to perform any additional functionality associated with the at least one device.

In some embodiments, the system is at least one element which services multiple user devices, and if necessary further comprises additional hardware, software, firmware or a combination thereof which enables the system to perform any additional functionality associated with the at least one element.

In some embodiments, the system further comprises: an output operable to output at least one direction relating to capturing audio, video and/or image data of the user.

In some of these embodiments, the output is independent of a user device associated with the input. In some cases, the output is associated with a device operable to receive a message.

In some of these embodiments, the output is associated with a user device which is also associated with the input.

In some embodiments, the system is further operable to determine that there is the authentication requirement.

In another aspect, the disclosed subject matter provides a validation system for online user authentication using audio, video and/or image data, comprising: a recognizer operable to receive audio, video, and/or image data captured by a user system, operable to attempt to confirm identity of a user of the user system, including operable to perform recognition on at least part of the received data, and operable, if confirmed, to generate a validation confirmation, thereby enabling a server to allow access, at least partly based on the validation confirmation or a part thereof, to a resource provided by the server which requires authentication of the user.

In some embodiments, the system further comprises: a director operable to determine at least one direction to be provided to the user system relating to capturing of audio, video and/or image data.

In some of these embodiments, the at least one direction includes a text which is supposed to correctly refer to the authentication requirement so that if the text, or audio and/or video data captured while the user says a text, does not correctly refer to the authentication requirement, then it is possible that the text or the captured audio and/or video data has been tampered with.

In some of these embodiments, the at least one direction includes text which does not have to refer to the authentication requirement.

In some embodiments of the system, the recognizer being operable to perform recognition includes: being operable to compare at least part of the received data to at least one direction relating to capturing of audio, video and/or image data.

In some embodiments of the system, the recognizer being operable to perform recognition includes: being operable to compare at least part of the received data to stored personal data associated with whom the user is claiming to be.

In some embodiments, the server is a web server.

In some embodiments, at least part of the system is included in the server.

In some embodiments, the system is not included in the server.

In some embodiments, the system is further operable to provide the confirmation or a part thereof to at least one of the user system or server.

In some embodiments, the system is further operable to provide at least part of the received data to the server during authentication.

In another aspect, the disclosed subject matter provides a server, operable to allow access to a resource which requires user authentication at least partly based on a validation confirmation or a part thereof, wherein the validation confirmation was generated after identity of a user of a user system was confirmed at least partly based on at least part of audio, video, and/or image data captured by the user system.

In some embodiments, the server is a web server.

In some embodiments, the server is further operable to receive at least part of the captured data.

In another aspect, the disclosed subject matter provides a method of online user authentication using audio, video and/or image data, comprising: capturing audio, video and/or image data of the user; and transmitting at least part of the captured data to a validation system, thereby enabling the validation system to generate a validation confirmation if identity of the user is confirmed at least partly based on at least part of the transmitted data.

In some embodiments, the method further comprises: receiving or determining at least one direction relating to capturing audio, video and/or image data of the user.

In some of these embodiments, the at least one direction includes at least one selected from a group comprising: direction relating to initiating the capturing of video, audio and/or image data, direction relating to stopping the capturing, direction relating to capture settings, direction relating to how user should speak, direction relating to what user should say, direction relating to how user should look, direction relating to desired medium, direction corresponding to desired language, direction relating to authentication requirement, direction relating to user speaking, direction relating to a text which user should say, direction which when presented is difficult for a machine to interpret, direction relating to capturing image, direction relating to gesture user should make, direction relating to facial expression that user should make, or direction relating to action that user should perform.

In some embodiments, the method further comprises: outputting at least one direction to the user relating to capturing audio, video and/or image data.

In some embodiments, the method further comprises: requesting direction from the validation system relating to capturing audio, video and/or image data of the user.

In some embodiments, the method further comprises: receiving at least part of the validation confirmation from the validation system, and transmitting at least part of the validation confirmation to the server.

In some embodiments, the method further comprises: generating a validation confirmation if identity of the user is confirmed at least partly based on at least part of the transmitted data.

In some embodiments, the method further comprises: allowing access to the resource at least partly based on the validation confirmation or a part thereof.

In some embodiments, the method further comprises: determining that there is the authentication requirement.

In some embodiments, the method further comprises: transmitting at least part of the captured data to the server.

In some embodiments, the server is a web server.

In another aspect, the disclosed subject matter provides a method of online user authentication using audio, video and/or image data, comprising: receiving audio, video, and/or image data captured by a user system; attempting to confirm identity of a user of the user system, including: performing recognition on at least part of the received data; and if confirmed, generating a validation confirmation, thereby enabling a server to allow access, at least partly based on the validation confirmation or a part thereof to a resource provided by the server which requires authentication of the user.

In some embodiments, the method further comprises: determining at least one direction to be provided to the user system relating to capturing of audio, video and/or image data.

In some embodiments, the method further comprises: receiving a request for direction relating to capturing audio, video and/or image data.

In some embodiments, the method further comprises: providing at least part of the received data to the server.

In some embodiments, the server is a web server.

In another aspect, the disclosed subject matter provides a method of online user authentication using audio, video and/or image data, comprising: allowing access to a resource which requires user authentication at least partly based on a validation confirmation or a part thereof, wherein the validation confirmation was generated after identity of a user of a user system was confirmed at least partly based on at least part of audio, video, and/or image data captured by the user system.

In some embodiments, the method is performed by a web server.

In another aspect, the disclosed subject matter provides a computer program product comprising a computer useable medium having computer readable program code embodied therein for online user authentication using audio, video and/or image data, the computer program product comprising: computer readable program code for causing the computer to capture audio, video and/or image data of the user; and computer readable program code for causing the computer to transmit at least part of the captured data to a validation system, thereby enabling the validation system to generate a validation confirmation if identity of the user is confirmed at least partly based on at least part of the transmitted data.

In another aspect, the disclosed subject matter provides a computer program product comprising a computer useable medium having computer readable program code embodied therein for online user authentication using audio, video and/or image data, the computer program product comprising: computer readable program code for causing the computer to receive audio, video, and/or image data captured by a user system; computer readable program code for causing the computer to attempt to confirm identity of a user of the user system, including: computer readable program code for causing the computer to perform recognition on at least part of the received data; and computer readable program code for causing the computer to generate a validation confirmation if confirmed, thereby enabling a server to allow access, at least partly based on the validation confirmation or a part thereof to a resource provided by the server which requires authentication of the user.

In another aspect, the disclosed subject matter provides a computer program product comprising a computer useable medium having computer readable program code embodied therein for online user authentication using audio, video and/or image data, the computer program product comprising: computer readable program code for causing the computer to allow access to a resource which requires user authentication at least partly based on a validation confirmation or a part thereof, wherein the validation confirmation was generated after identity of a user of a user system was confirmed at least partly based on at least part of audio, video, and/or image data captured by the user system.

### BRIEF DESCRIPTION OF THE DRAWINGS

In order to understand the presently disclosed subject matter and to see how it may be carried out in practice, embodiments will now be described, by way of non-limiting example only, with reference to the accompanying drawings, in which:

FIG. 1A is a high level block diagram of a network for online user authentication, according to some embodiments of the presently disclosed subject matter;

FIG. 1B is a high level block diagram of a network for online user authentication, according to some embodiments of the presently disclosed subject matter;

FIG. 2 is a flowchart illustration of a method for online user authentication using audio image and/or video data, performed by a user system, according to some embodiments of the presently disclosed subject matter; and

FIG. 3 is a flowchart illustration of a method for online user authentication using audio image and/or video data, performed by a validation system, according to some embodiments of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

Embodiments of the presently disclosed subject matter relate to online authentication using audio, image and/or video data. In some of these embodiments, audio, video and/or image data of a user may be captured, and recognition may be performed on at least part of the captured data during an attempt to confirm that the user is who he/she is supposed to be. If the attempt is successful, a validation confirmation may be generated. In some examples of these embodiments, the validation confirmation or a part thereof may optionally be provided to a server during user authentication relating to a resource provided by the server. Additionally or alternatively, in some examples of these embodiments, at least part of the captured data may optionally be provided to the server during authentication. Depending on the embodiment, the server may or may not be a web server.

In the following detailed description, numerous specific details are set forth in order to provide a thorough understanding of the presently disclosed subject mater. However, it will be understood by those skilled in the art that some examples of the presently disclosed subject matter may be practiced without these specific details. In other instances, well-known methods, procedures and components have not been described in detail so as not to obscure the subject matter.

As used herein, the phrase “for example,” “such as”, “for instance”, “e.g.”, and variants thereof describe non-limiting embodiments of the subject matter.

As used herein, user validation refers to substantiation of the identity of a user (i.e. proving the identity of the user, or in other words proving that the user is who he/she is supposed to be). As used herein, user authentication refers to the provision of user credential(s) (or the acceptance of provided user credential(s)) when attempting to gain access (or before allowing access) to a resource. Online (user) authentication refers to the provision of user credential(s) (or the acceptance of provided user credential(s)) when attempting to gain access (or before allowing access) to a resource provided by a server.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one non-limiting embodiment of the presently disclosed subject matter. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features, structures, and/or characteristics, which are, for clarity, described in the context of separate embodiments, may also be provided in combination in a single embodiment. Conversely, various features, structures and/or characteristics which are, for brevity, described in the context of a single embodiment, may also be provided separately or in any suitable sub-combination.

Unless specifically stated otherwise, as apparent from the following discussions, it is appreciated that throughout the specification discussions utilizing terms such as “accessing”, “receiving”, “collecting”, “hosting”, “validating”, “providing”, “assisting”, “performing”, “transmitting”, “sending”, “authenticating”, “communicating”, “storing”, “retrieving”, “inputting”, “outputting”, “determining”, “using”, “informing”, “detecting”, “enabling”, “causing”, “obtaining”, “executing”, “allowing”, “attempting”, “processing”, “confirming”, “calling”, “gaining”, “capturing”, “proving”, “generating”, “confirming”, “recognizing”, “comparing”, “matching”, “stopping”, “initiating”, “requesting”, “offering”, “supplying”, “tampering”, “retaining”, or the like, refer to the action and/or processes of any combination of software, hardware and/or firmware. For example, these terms may refer in some cases to the action and/or processes of a machine, that manipulates and/or transforms data into other data, the data represented as physical, such as electronic quantities, and/or the data representing physical objects.

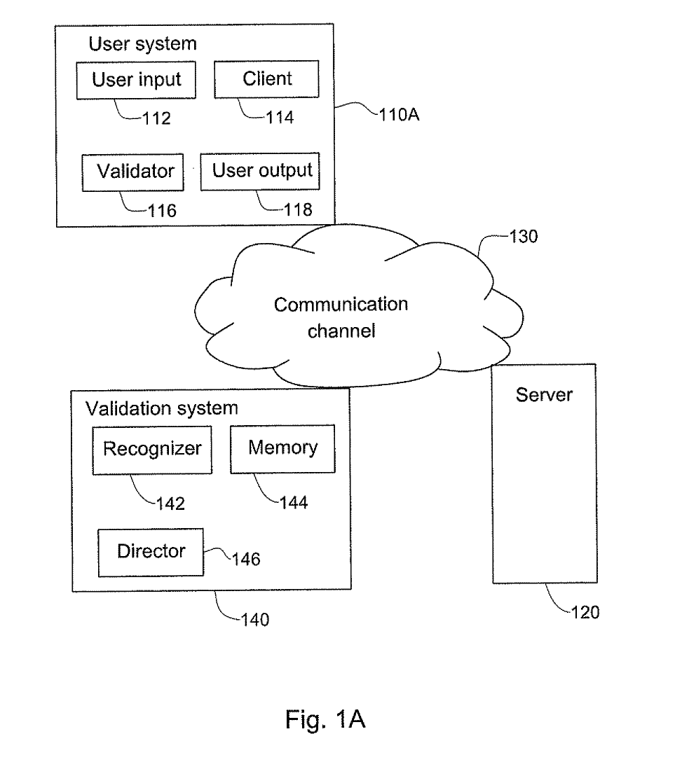

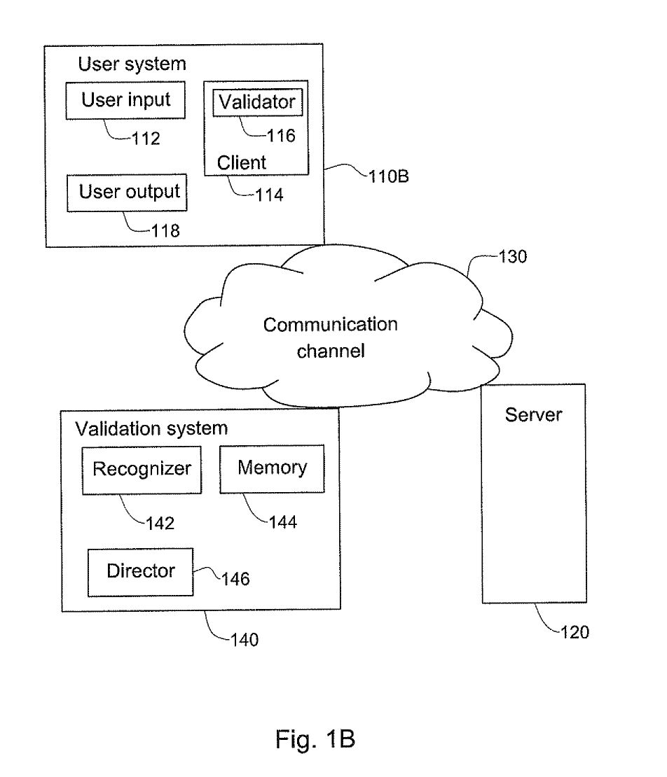

Referring now to the drawings, FIGS. 1A and 1B schematically illustrate examples of networks 100A and 100B, respectively for online user authentication using audio, image and/or video data, according to some embodiments of the presently disclosed subject matter.

In the illustrated embodiments, network 100A and 100B respectively include one or more user systems 110A or 110B, one or more servers 120, one or more validation systems 140 and one or more communication channels 130. When included, each user system 110A, user system 110B, server 120, and/or validation system 140 may be made up of any combination of hardware, software and/or firmware capable of performing the operations as defined and explained herein. For example, in some embodiments, any of user system(s) 110A, user system(s) 110B, server(s) 120, and/or validation system(s) 140 may comprise a machine specially constructed for the desired purposes, and/or may comprise a programmable machine selectively activated or reconfigured by specially constructed program code. Additionally or alternatively, in some embodiments, any of user system(s) 110A, user system(s) 110B, server(s) 120, and/or validation system(s) 140 may comprise at least some hardware.

For simplicity of illustration and description, user system(s) 110A, user system(s) 110B, server 120, communication channel 130, and validation system 140 are generally referred to below in the single form, but usage of the single form for any particular element should be understood to include both embodiments where there may be one of the particular element in network 100A or 100B and embodiments where there may be a plurality of the particular element in network 100A or 100B.

For simplicity of illustration and description, validation system 140 is separately illustrated and described from server 120, with communication between validation system 140 and server 120 shown and described as being via communication channel 130. However, depending on the embodiment, part or all of validation system 140 may be included in server 120 and/or part or all of validation system 140 may be separate from server 120.

Features of user system 110A and/or user system 110B may vary depending on the embodiment. For example, in various embodiments module(s) in user system 110A and/or user system 110B may be included in one or more user device(s) such as a personal computer, cell phone, smartphone, laptop, tablet computer, etc., may be included in element(s) which service multiple user devices such as proxy server(s), gateway(s), other types of servers, etc, and/or may be included in a combination of the above.

In the illustrated embodiments, user system 110A and/or user system 110B includes one or more client modules 114, one or more validator modules 116, and one or more user input modules 112. Optionally, user system 110A and/or user system 110B may also include one or more user output modules 118. When included, each module in user system 110A and/or user system 110B may be made up of any combination of hardware, software and/or firmware capable of performing the operations as defined and explained herein. For simplicity of illustration and description, user input 112, client 114, validator 116, and user output 118 are generally referred to below in the single form, but usage of the single form for any particular element should be understood to include both embodiments where there may be one of the particular module in user system 110A and/or user system 110B and embodiments where there may be a plurality of the particular module in user system 110A and/or user system 110B.

Examples of user input 112 may comprise any module configured to input audio, video, and/or image data (and optionally configured to input other data). Examples of user output 118 (when included) may comprise any module configured to output direction(s) to a user (and optionally configured to output other data). Examples of input 112 and/or output 118 may include keyboard, mouse, camera, keypad, touch-screen display, microphone, speaker, non-touch-screen display, and/or printer, etc. It is noted that when a particular user input module 112 and a particular user output module 118 are described, the particular user input module 112 and particular user output module 118 may be located in the same unit or in separate units, depending on the embodiment. If in separate units, the separate units may or may not be in proximity to each other.

Client 114 may be configured to attempt to gain access to and/or may be configured to access resource(s) provided by server(s) such as server 120. In some embodiments, server 120 may be a web server and client 114 may be a web browser or other application configured to attempt to gain to and/or configured to access resource(s) hosted on web server(s), such as web site(s) hosted on server 120. In embodiments where client 114 may be a web browser or other application, the web browser or other application may include any web browser or other application such as Internet Explorer®, Firefox®, Google Chrome™, Safari®, etc which may be currently commercially available or may be available in the future. In some other embodiments, client 114 may not be a web browser or other application.

Validator 116 may be configured to transmit to validation system 140 audio, video and/or image data of a user of client 114 which may validate or may assist in validating (i.e. may prove or may assist in proving the identity of) the user so that validation system 140 may confirm validation (i.e. may confirm the identity of the user), if should be confirmed, based at least partly on audio, video and/or image data. In some embodiments, other data which may assist in validating the user (e.g. user identifier and/or password, etc) may also be transmitted to validation system 140 and may also be relied upon by validation system 140 when attempting to confirm the identity of the user.

In the example of user system 110A, validator 116 is external to client 114 and therefore may also be configured to enable at least one validation item which may be provided to server 120 during online user authentication to be protected from possible tampering by client 114 as described in co-pending application Ser. No. 13/356,042, titled “Protecting Web Authentication Using External Module”, filed on Jan. 23, 2012, which is hereby incorporated by reference herein. Continuing with the example, the validation item(s) which may be protected may include audio data, video data, image data, validation confirmation, indication of validation confirmation generation, and/or a part thereof, etc. Still continuing with the example, in various cases of user system 110A, validator 116 may be included in: a plug-in, an add-on, a toolbar or an applet for client 114; a stand-alone client (e.g. separate application); any other suitable element in a user device; any other suitable element servicing multiple user devices; and/or an element with any other suitable configuration, etc. In this example, assuming instances where validator 116 runs code, depending on the instance validator 116 may or may not run code that is in the same process space as the space of client 114. In some of these instances, validator 116 may or may not spawn a separate operating system process for performing function(s) assigned to validator 116 which does not include all add-ons of client 114, some of which may be malicious. In some of these instances, where validator 116 and client 114 are included in a user device of a user, validator 116 may be included in the same user device or in a different user device than client 114 (for instance, one included in a personal computer and the other in a cell phone).

In the example of user system 110B, validator 116 is included in client 114 (meaning a client or client version which is not currently commercially available but which may be available in the future may include the functionality of validator 116).

Depending on the embodiment, modules in user system 110A and/or user system 110B may be concentrated in the same location, for instance in one unit or in various units in proximity of one another, or modules of user system 110A and/or user system 110B may be dispersed over various locations.

In some cases, user system 110A and/or user system 110B may comprise fewer, more, and/or different modules than those shown in FIG. 1A and/or FIG. 1B. Additionally or alternatively, in some cases, the functionality of user system 110A and/or user system 110B described herein may be divided differently among the modules shown in FIG. 1A and/or FIG. 1B. Additionally or alternatively, in some cases, the functionality of user system 110A and/or user system 110B described herein may be divided into fewer, more and/or different modules than shown in FIG. 1A and/or FIG. 1B, and/or user system 110A and/or user system 110B may include additional, less and/or different functionality than described herein. For instance, in some of these cases user system 110A and/or user system 110B may be one or more user devices and/or one or more elements which services multiple user devices, and therefore may also include, if necessary, additional hardware, software, firmware or a combination thereof to perform any additional functionality associated with the user device(s) and/or element(s).

In this disclosure, reference to “network” or network 100 (without a letter designation) should be understood to refer to network 100A and/or to network 100B. In this disclosure, reference to “user system” or user system 110 (without a letter designation) should be understood to refer to user system 110A and/or to user system 110B. In the disclosure, reference to FIG. 1 (without a letter designation) should be understood to refer to FIG. 1A and/or FIG. 1B.

Features of server 120 may vary depending on the embodiment. For example, server 120 may be configured to authenticate or not authenticate, if and when necessary, a user whose client 114 is attempting to access a resource provided by server 120. Additionally or alternatively, for example, server 120 may be configured to allow access to the resource which requires online user authentication at least partly based on a validation confirmation or a part thereof (for instance. at least partly based on a received validation confirmation or part thereof, and/or at least partly based on a received indication that a validation confirmation was generated, or a part thereof).

Features of validation system 140 may vary depending on the embodiments. For example, validation system 140 may be configured to attempt to confirm validation (i.e. attempt to confirm the identity of the user) based at least partly on audio, video and/or image data of a user, and to generate a validation confirmation if confirmed. In some of these embodiments, part or all of validation system 140 may be included in a gateway, proxy server, other type of server, any other element servicing multiple user devices, etc.

In the illustrated embodiments, validation system 140 includes one or more recognizer modules 142. Optionally, validation system 140 may also include one or more memory modules 144, and/or one or more director modules 146. When included, each module in validation system 140 may be made up of any combination of hardware, software and/or firmware capable of performing the operations as defined and explained herein. For simplicity of illustration and description, recognizer 142, memory 144, and director 146 are generally referred to below in the single form, but usage of the single form for any particular element should be understood to include both embodiments where there may be one of the particular module in validation system 140 and embodiments where there may be a plurality of the particular module in validation system 140.

Recognizer 142 may be configured to perform any type of recognition, including speech, speaker, image and/or video recognition. The disclosure does not impose limitations on recognizer 142 but for the sake of further illustration to the reader, some examples of commercially available products, any of which may be included in recognizer 142 will now be provided. Examples may include voice biometric (AKA also known as speaker recognition) products by companies such as Authentify®, Salmat Speech Solutions®, and/or Nuance Communications® (e.g. VocalPassword™ and/or FreeSpeech, etc), etc; speech to text (AKA speech recognition) products such as Siri™ (by Apple®), etc; video recognition products by companies such as 3VR®, Cernium®, and/or Eptascape™, etc; and/or image recognition products such as Picasa® (by Google™), etc. Additionally or alternatively, any appropriate algorithm(s) may be used by recognizer 142. Examples of possible algorithms which may be used by recognizer 142 may include any of the following: Principal Component Analysis, Linear Discriminate Analysis, Elastic matching, Hidden Markov Model, Dynamic Link Matching, Dynamic time warping, Acoustic Modeling, Language Modeling, Frequency Estimation, Gaussian Mixture Models, Pattern Matching, Neural Network, Matrix Representation, and/or Decision Trees, etc.

Depending on the embodiment, recognizer 142 may or may not be configured to perform other (non-recognition) operation(s) during an attempt to confirm the identity of the user.

Director 146 (when included) may be configured to determine direction(s) relating to validation. Memory 144 (when included) may include any module for storing data for short and/or long term, locally and/or remotely. Examples of memory 144 may include inter-alia: any type of disk including floppy disk, hard disk, optical disk, CD-ROM, magnetic-optical disk, magnetic tape, flash memory, random access memory (RAM), dynamic random access memory (DRAM), static random access memory (SRAM), read-only memory (ROM), programmable read only memory (PROM), electrically programmable read-only memory (EPROM), electrically erasable and programmable read only memory (EEPROM), magnetic card, optical card, any other type of media suitable for storing electronic instructions and capable of being coupled to a system bus, a combination of any of the above, etc.

As mentioned, depending on the embodiment, validation system 140 may or may not be at least partly included in server 120. In embodiments where validation system 140 is configured to provide validation item(s) (e.g. audio data, video data, image data, validation confirmation, indication that validation confirmation was generated, and/or part thereof, etc) to server 120, validation system 140 may be configured to provide the validation items) to server 120 which may be configured to perform online user authentication, for instance by transmission via channel 130 (if at least part of validation system 140 is not included in server 120) and/or for instance by internal transfer (if at least part of validation system 140 is included in server 120).

Depending on the embodiment, modules in validation system 140 may be concentrated in the same location, for instance in one unit or in various units in proximity of one another, or modules of validation system 140 may be dispersed over various locations. For instance, in some embodiments, different recognizer modules 142 (and/or any other modules of validation system 140) may be dispersed over various locations (e.g. various servers and/or services, etc.). Continuing with this instance, in some of these embodiments, recognizer 142 may use various OEM solutions, web service solutions, etc. for performing various recognition operations.

In some cases, validation system 140 may comprise fewer, more, and/or different modules than those shown in FIG. 1A and/or FIG. 1B. Additionally or alternatively, in some cases, the functionality of validation system 140 described herein may be divided differently among the modules shown in FIG. 1A and/or FIG. 1B. Additionally or alternatively, in some cases, the functionality of validation system 140 described herein may be divided into fewer, more and/or different modules than shown in FIG. 1A and/or FIG. 1B, and/or validation system 140 may include additional, less and/or different functionality than described herein.

Features of communication channel 130 may vary depending on the embodiment. For example, in various embodiments, there may be one or more communication channel(s) 130 between any pair of elements in network 100, and any communication channel 130 between any pair of elements in network 100 may comprise any suitable infrastructure for network 100 that provides direct or indirect connectivity between those two elements. It is noted that a communication channel between one pair of elements in network 100 may or may not be the same as a communication channel between another pair of elements in network 100. Communication channel 130 may use for example one or more wired and/or wireless technology/ies. Examples of channel 130 may include cellular network channel, personal area network channel, local area network channel, wide area network channel, internetwork channel, Internet channel, any combination of the above, etc.

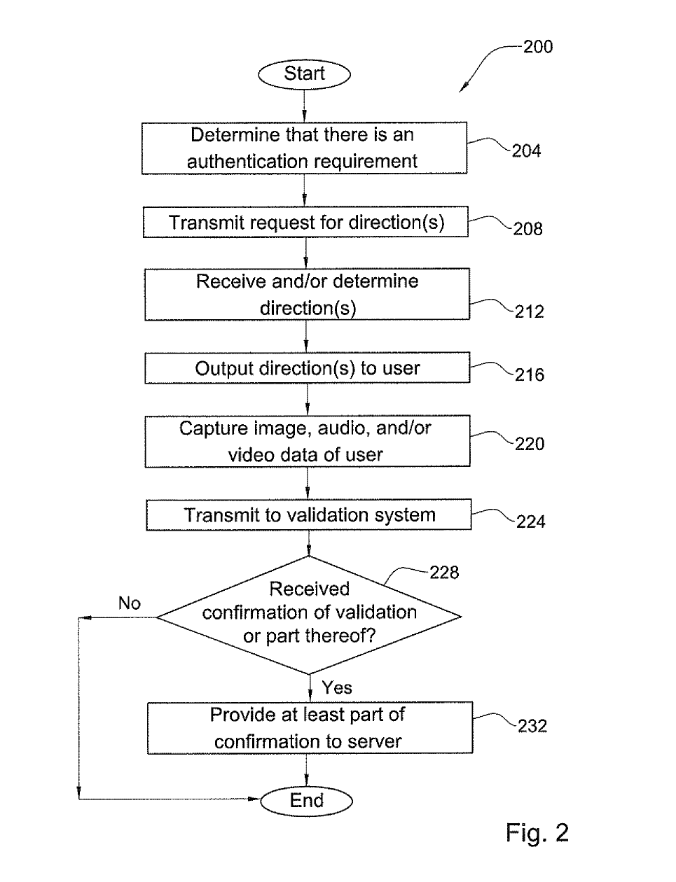

FIG. 2 is a flowchart illustration of a method 200 for online user authentication using audio, image and/or video data, according to some embodiments of the presently disclosed subject matter. In some cases, method 200 may be performed by user system 110. In some cases, method 200 may include fewer, more and/or different stages than illustrated in FIG. 2, the stages may be executed in a different order than shown in FIG. 2, stages that are illustrated as being executed sequentially may be executed in parallel, and/or stages that are illustrated as being executed in parallel may be executed sequentially.

In the illustrated embodiments, in optional stage 204, a requirement for authentication of the user (of client 114) vis-a-vis server 120 is determined by user system 110. For instance, in order for client 114 to be able to gain access to a resource provided by server 120, there may be a requirement for user authentication. The subject matter does not limit how the determination of the requirement is made. For instance, in various of these embodiments, client 114 may determine that there is a requirement and/or validator 116 (which may be internal or external to client 114) may determine that there is a requirement. In some examples where server 120 is a web server and client 114 is a web browser or application, the requirement for authentication may relate to a web site hosted at the web server. Depending on the embodiment, the determination may be made by any suitable action, such as any of the following actions: using the Uniform Resource Locator (URL) (e.g. matching the URL to a URL in a list of URLs which require authentication), examining the HyperText Markup Language (HTML) content, examining the HyperText Transport Protocol (HTTP) content, using a script, detecting that a password is required (e.g. detecting a password input field in the HTML), detecting an element (e.g. HTML) with a predefined identifier that is associated with required authentication, detecting usage of a biometric device such as a fingerprint reader, detecting an application programmable interface API (for instance in Javascript) which may be called to continue method 200, detecting that user authentication is required either at the beginning or later in the process when client 114 is attempting to access a resource (such as opening a secure message, confirming an online operation which requires authentication (e.g. transferring funds), and/or logging on, etc.), receiving notification that there is a requirement for web user authentication from server 120 and/or from validation system 140, a combination of any of the above, etc.

In some cases where stage 204 is performed, where validator 116 is external to client 114 and where the requirement for authentication is determined by client 114, the remainder of method 200 may be triggered by client 114 calling an application programmable interface API that is provided by validator 116 or by the operating system. However in some other cases, the remainder of method 200 may be additionally or alternatively triggered by some other action, or may proceed without being triggered by any particular action.

In some of these embodiments, stage 204 may be omitted, for instance if user system 110 may become aware of an authentication requirement due to the receipt of direction(s) from validation system 140 in stage 212. In some cases where user system 110 may become aware of an authentication requirement due to the receipt of direction(s) from validation system 140 in stage 212, validation system 140 may have become aware of the authentication requirement after receiving a request from server 120 as described below with reference to stage 304.

In the illustrated embodiments, in optional stage 208, user system 110, for instance validator 116, transmits a request for direction(s) via a channel in network 100 (e.g. channel 130) to validation system 140. Depending on the embodiment, the transmitted request may or may not include data which validation system 140 may use in determining direction(s). For instance, included data may relate to the requirement for authentication. Continuing with this instance, if the requirement for authentication was detected for an online operation, secure message, and/or relating to a specific website, the data may include details on the online operation, secure message and/or website, respectively. Additionally or alternatively, for instance, included data may relate to the desired medium/media for capturing such as audio, video and/or image so that validation system 140 may provide direction corresponding to the desired medium/media Additionally or alternatively, for instance, included data may relate to the preferred language for audio and/or video capture so that validation system 140 may provide direction(s) corresponding to the preferred language.

In some of the embodiments, stage 208 may be omitted, for instance if no direction(s) is/are to be received from validation system 140 prior to capturing stage 220, and/or if direction(s) may be sent by validation system 140 without first receiving a request from user system 110.

In the illustrated embodiments, in stage 212, user system 110, for example validator 116 receives direction(s) from validation system 140 via a channel in network 100 (e.g. channel 130) and/or determines direction(s). In some of these embodiments, the received and/or determined direction(s) may relate to capturing audio, video, and/or image data of the user.

In embodiments where direction(s) may be received, user system 110, for instance validator 116 may or may not check received direction(s) for appropriateness, depending on the embodiment. For instance, a received direction may not be considered appropriate if the direction does not correspond to data included in the request (if any). Additionally or alternatively, for instance, a received direction may not be considered appropriate if identical to any one of a predetermined number of previously received directions or any previously received direction(s). Additionally or alternatively, for instance, a received direction may not be considered appropriate for the user or user system 110 due to its format and/or content. For example, a received direction may not be in a format understandable by user system 110, the content may be unclear or too complex for the user or user system 110, the content may be too simple to allow reliable user validation, and/or the format and/or content may be problematic in any other way. Additionally or alternatively, for instance, a received direction may not be considered appropriate, for any other reason. If received direction(s) is/are not considered appropriate then validator 116 may request and receive different direction(s) from validation system 140, and/or validator 116 may modify the received direction(s).

In some embodiments where direction(s) may be determined, validator 116 may determine direction(s) by generating direction(s) or by modifying received direction(s). Direction(s) may be generated because direction(s) may not have been received from validation system 140. For instance, direction(s) may not have been received if standard and therefore already known to validator 116, if unnecessary because validation system 140 may be configured to perform recognition on any type of captured audio, video and/or image data, if direction(s) may be determined by validator 116 and transmitted to validation system 140 before validation system 140 performs recognition on captured audio, video and/or image data, and/or for any other reason. Direction(s) may be modified because the received direction may not be considered appropriate and/or for any other reason. In embodiments where received direction(s) may be modified, the format and/or content of a received direction may be modified, for instance by validator 116 adding parameter(s), changing parameter(s) and/or deleting parameter(s). Continuing with this instance for added parameter(s), validator 116 may in some cases add specifics to a received direction relating to capturing of audio, video and/or image data, such as adding detail(s) relating to the requirement for authentication (e.g. relating to an online transaction, secure message and/or website, etc) to text(s) included in the received direction (perhaps instead of including the details in the request of stage 208), adding instruction(s) that the user should speak and/or how the user should speak and/or look while the audio, image, and/or video data is being captured (e.g. say something, talk clearly, turn head so left ear may be captured, do not wear any head covering, etc), adding what the user should say such as additional text(s) that the user should say, adding direction(s) which may be presented in a manner that makes it difficult for a machine to interpret such as an image with skewed text which may be difficult for an optical recognition algorithm to interpret (e.g. CAPTCHA), adding additional action(s) that a user should perform while a video is being captured, adding gesture(s) and/or facial expression(s) that a user should make while an image or video is being captured, etc. Additionally or alternatively in some cases of this instance, validator 116 may add parameter(s) by adding direction(s) for different data unit(s) to be captured (e.g. additional data unit(s) of audio, video, and/or image data) in addition to the data unit(s) for which direction(s) was received. In some of these cases, the different data unit(s) may use(s) different medium/media, so that if the received direction(s) related to audio, then the different data unit(s) may relate to video and/or image, if the received direction(s) related to audio and video, then the different data unit(s) may relate to image, etc. However in other of these cases, at least one different data unit may use the same medium as at least one data unit(s) for which direction(s) were received. Continuing with this instance for changed and/or deleted parameter(s), in some cases where the received direction(s) relates to capturing a plurality of data units, validator 116 may delete direction(s) relating to a subset of the plurality of data units, possibly substituting direction(s) for different data unit(s). In some of these cases with substitution, the different data unit(s) may use(s) different medium/media, so that if the deleted direction(s) related to audio, then the different data unit(s) may relate to video and/or image, if the deleted direction(s) related to audio and video, then the different data unit(s) may relate to image, etc. However in other of these cases with substitution, at least one different data unit may use the same medium as at least one data unit(s) for which direction(s) were deleted. Additionally or alternatively, in some cases of this instance for changed and/or deleted parameter(s), validator 116 may change or delete specifics to the received direction(s) such as changing or deleting what the user should say such as changing or deleting text(s), changing or deleting direction(s) which may be presented in a manner that is difficult for a machine to interpret, changing or deleting instruction(s) that the user should speak and/or how the user should speak and/or look, changing or deleting action(s) that a user should perform while a video is being captured, changing or deleting gesture(s) and/or facial expression(s) that a user should make while an image or video is being captured, etc. Additionally or alternatively, in some cases of this instance for changed and/or deleted parameter(s), the format of received direction(s) may be modified. Depending on the embodiment, a determined direction (e.g. generated or modified) may or may not be required to be transmitted to validation system 140 prior to validation system 140 performing recognition of the captured audio, video and/or image.

The disclosure does not impose limitations on the format and/or content of the direction(s) (received and/or determined). For instance, if a direction or part of a direction is to be outputted to the user, the format of the outputted direction or part thereof may include any appropriate format which may be outputted to the user, for instance that may be seen and/or heard by the user. Continuing with this instance, the format may allow the user to hear the direction(s), to view the direction(s), to hear part of the direction(s) and view a different part of the direction(s), to hear and view the direction(s), etc. Additionally or alternatively, for instance, if a direction includes direction to module(s) of user system 110 (e.g. input 112) for capturing, the format may include any appropriate format understandable by the module(s). Additionally or alternatively, for instance, if a direction is to be received and/or determined by module(s) in user system 110 (e.g. validator 116), the format may include any appropriate format understandable by the module(s). Additionally or alternatively, the format of a direction may make it difficult when presented for a machine to interpret.

Although the disclosure does not impose limitations on the content of the direction(s), for the sake of further illustration to the reader, some examples are now provided which illustrate possible content of direction(s) relating to capturing audio, video, and/or image data of the user.

In one example, direction(s) to module(s) such as input 112 and/or to the user may relate to initiating the capturing of video, audio and/or image data, stopping the capturing, and/or capture settings. Some cases of this example include direction(s) for starting/stopping capturing video by camera, capturing an image by camera, microphone turning on/off so as to capture/not capture sound, changing the camera setting(s) (e.g. zoom, focus zone, resolution, etc), etc. In some cases of this example, the direction(s) may include instruction(s) to the user to enable the image capturing, and/or to enable the beginning and/or ending of audio and/or video capturing (e.g. by pressing a button) whereas in other cases of this example, the direction(s) may additionally or alternatively include instruction(s) to module(s) (e.g. input 112) to automatically capture image, audio and/or video data of the user, perhaps with module(s) (e.g. output 118) providing a countdown to the user so that the user may behave appropriately. In another example, direction(s) may additionally or alternatively include instruction(s) on how the user should speak and/or look (e.g. speak slowly, do not wear any glasses not usually worn, face the camera, etc). In another example, direction(s) may additionally or alternatively be at least partly based on data included in the request. For instance, in this example if the request included the desired medium/media, the direction(s) may relate to capturing data in the desired medium/media (e.g. audio, video and/or image). Additionally or alternatively for instance in this example if detail(s) on the authentication requirement were included in the request, one or more of the detail may be included in the direction(s), perhaps in a text included in the direction(s). Additionally or alternatively, for instance in this example if the request included the preferred language, the direction(s) may correspond to the preferred language. In another example, direction(s) may additionally or alternatively include instruction(s) that the user should speak while audio and/or video data is being captured, without necessarily specifying what the user should say. In another example, the direction(s) may additionally or alternatively include what the user should say such as text(s) (each including one or more sounds, syllables, words, and/or sentences) which the user should say (e.g. read out loud) when audio and/or video data is being captured. In various cases of this example, the included text(s) may be the same or different than previous text(s) that the user was requested to say. Additionally or alternatively, in some cases of this example, the content of a text may allow the user and/or validation system 140 to recognize if the text has been tampered with, whereas in other cases of this example the content of a text may not necessarily allow the user and/or validation system 140 to recognize that the text has been tampered with. For instance, a text may be supposed to include a correct reference to the requirement for authentication. Continuing with this instance and assuming the requirement for authentication related to transfer of funds, a text may be supposed to include a reference to the correct destination of the funds so that if the text was tampered with and the destination changed (e.g. by man in the browser and/or other malware, man in the middle and/or other eavesdropping, etc), the user may realize that the text may have been tampered with and if desired take appropriate action. Additionally or alternatively, in some cases of this example, the content of a text may be randomly determined and therefore may be unlikely to be related to the authentication requirement (i.e. does not have to refer to the authentication requirement). In some of these cases, a random text may be less likely to be guessed at and included in a (fake) direction by a party other than validation system 140 and validator 116 (than a text which was not randomly determined). In another example, direction(s) may additionally or alternatively include direction(s) which may be presented in a manner that makes it difficult for a machine to interpret such as an image with skewed text which may be difficult for an optical recognition algorithm to interpret (e.g. CAPTCHA). In another example, direction(s) may additionally or alternatively include direction(s) that an image of the user should be captured, without necessarily providing further specifics regarding the image. In another example, direction(s) may additionally or alternatively specify gesture(s) and/or facial expression(s) that a user should make when an image is being captured (e.g. smile, show three fingers, etc). In another example, direction(s) may additionally or alternatively include direction(s) that a video of the user should be captured, without necessarily providing further specifics regarding the video. In another example, direction(s) may additionally or alternatively specify action(s) to be performed, what to say (e.g. text(s) to be said), gesture(s) and/or facial expression(s) to be made when the video is being captured (e.g. speak, say a certain text, first jump then clap and then turn around three times, frown, show two fingers, etc.)

In the illustrated embodiments, in optional stage 216, user system 110, for instance output 118, outputs at least part of the direction(s) to the user.

In some of these embodiments, at least part of the direction(s) to be outputted may be provided by validator 116 to an output 118 which is associated with a user device that is independent of any input 112 which will be used to capture the audio, video and/or image data. For instance, instruction(s) regarding enabling data capture and/or the beginning and/or ending of data capturing, instructions to speak and/or how to speak and/or look, what the user should say such as text(s) to be said by the user, direction(s) which may be presented in a manner that is difficult for a machine to interpret, and/or a description of action(s), gesture(s) and/or facial expressions to be captured, may be transmitted via a channel in network 100 (e.g. channel 130) as a message (e.g. Short Message Service SMS, Multimedia Messaging Service MMS, electronic mail, etc) to a cellular phone, smartphone, or any other device configured to receive the message) of the user for output via output 118 which is associated with (e.g. part of or attached to) the cellular phone, smartphone, or any other device configured to receive the message. However in this instance, input 112 which may be used to capture the audio, video and or image may be instead associated with (e.g. attached to or part of) a different user device (e.g. the user's desktop, laptop, tablet computer, or any other user device)

In some of these embodiments, at least part of the direction(s) may be provided by validator 116 to an output 118 which is associated with a user device that is also associated with one or more input module(s) 112 which will be used to capture the audio, video, and/or image data. For instance, instruction(s) regarding enabling data capture and/or the beginning and/or ending of data capturing, instructions to speak and/or how to speak and/or look, what the user should say such as text(s) to be said by the user, direction(s) which may be presented in a manner that is difficult for a machine to interpret, and/or a description of action(s), gesture(s) and/or facial expressions to be captured may be displayed and/or heard on a display and/or on a speaker associated with a user device (e.g. part of or attached to the user device). In this instance, one or more of input module(s) 112 (e.g. microphone and/or camera, etc.) which will be used to capture the audio, video and/or image may also be associated with the same user device (e.g. part of or attached to the user device). In this instance, however, not necessarily all input module(s) 112 used to capture may be associated with the same user device.

In some of these embodiments, one or more of the direction(s) may not necessarily be outputted to the user, for instance because one or more direction(s) may be directed to module(s) such as input 112 and not to the user.

In the illustrated embodiments, in stage 220, user system 110, for instance input 112, captures audio, video and/or image data. For example, the user's voice may be captured in an audio only recording or in a video recording. Additionally or alternatively, for example the user's physical appearance may be captured in an image or in a video recording. Additionally or alternatively, for example, action(s), gesture(s), and/or facial expressions, etc. may be captured in an audio only recording (e.g. action of speaking), image, or video recording.

The disclosure does not limit the number of data unit(s) of audio recording(s), video recording(s) and/or image(s) which are captured in stage 220, and any appropriate number may be captured as long as at least one data unit of audio, video and/or image is captured. The disclosure additionally does not limit the capturing to one type of medium or alternatively to a plurality of types of media, and therefore, depending on the embodiment, only one type of medium (e.g. image, video or audio) may be captured or a plurality of types may be captured.

In the illustrated embodiments, in stage 224 part or all of the captured video, audio and/or image data is transmitted by user system 110, for instance by validator 116 to validation system 140 via a channel in network 100 (e.g. channel 130). Optionally, the direction(s) corresponding to the transmitted captured data may be transmitted, for instance because validation system 140 may not have the direction(s) (e.g. validation system 140 may not have sent direction(s) or the direction(s) sent may have been modified) and may require the direction(s) for recognition of the transmitted captured data. The direction(s) may optionally be transmitted to validation system 140, additionally or alternatively, for identification of previously sent direction(s), to check that the direction(s) were not tampered with, and/or for any other reason. Optionally, user system 110, for instance validator 110, may transmit other data (e.g. user identifier and/or password, etc.) to validation system 140 via a channel in network 100 (e.g. channel 130), for instance data which may assist in validating (i.e. proving the identity) the user.

In the illustrated embodiments, in optional stage 228, user system 110, for instance validator 116 determines if a validation confirmation or a part thereof was received from validation system 140. If confirmation or part thereof was received, then in optional stage 232, user system 110, for instance client 114 or validator 116 provides at least part of the validation confirmation to server 120 during authentication via a channel in network 100 (e.g. channel 130). Alternatively, stages 228 and/or 232 may be omitted, for instance because the validation confirmation or a part thereof may be provided additionally or alternatively by validation system 140 to server 120 (for instance as part of method 300 described below), because the validation confirmation or part thereof may not be provided to server 120, and/or because the validation confirmation or a part thereof may not be required by user system 110.

In the example of user system 110A the validation confirmation or a part thereof may optionally be protected from possible tampering by client 114 as described in the aforementioned co-pending application Ser. No. 13/356,042.

Assuming embodiments where at least part of a validation confirmation is confirmation provided to server 120 by validation system 140 and by user system 110, then depending on the embodiment validation system 140 and user system 110 may provide the same at least part or different parts. For example, a validation confirmation may possibly include in some cases an “okay” (or similar) response and/or a validation token. In some of these cases, where the validation confirmation includes both an “okay” (or similar) response and a validation token, validation system 140 and user system 110 may provide both, validation system 140 may provide both, user system 110 may provide both, validation system 140 may provide the “okay” (or similar) and user system 110 the token, or validation system 140 may provide the token and user system 110 the okay (or similar).

In some embodiments, no validation confirmation or part may be provided to server 120 during authentication. For example validation system 140 may additionally or alternatively store internally an indication that a validation confirmation was generated for an identifier associated with the validation. During the user authentication, server 120 may check with validation system 140 that a validation confirmation was generated for that identifier. Validation system 140 may then provide to server 120 an indication that a validation confirmation was generated, or a part thereof.

Optionally, user system 110 and/or validation system 140 may be required to provide different item(s) such as the captured video, audio and/or image data, a part thereof, indication that a validation confirmation was generated, any other item(s) (e.g. user identifier and/or password, etc.) and/or a part thereof to server 120 as credentials for authentication, in addition to or instead of a validation confirmation or part thereof. In the example of user system 110A any of the additional item(s) may optionally be protected from possible tampering by client 114 as described in the aforementioned co-pending application Ser. No. 13/356,042.

For instance, in some embodiments where captured video, audio and/or image data is provided to server 120 by user system 110 and/or validation system 140, all captured video, audio and/or image data may be provided even if not all are necessary credentials for authentication, whereas in other cases only captured data which may be necessary credentials for authentication (and which may include all or only some of the captured data) may be provided.

Depending on the embodiment, any validation item(s) (e.g. validation confirmation or part thereof; captured audio, video and/or image data or a part thereof; indication that validation confirmation was generated or a part thereof, and/or other item(s) or a part thereof, etc) which may be provided by user system 110 and/or validation system 140 to a server such as server 120 during online user authentication may or may not vary depending on the server and/or resource for which authentication is required. Depending on the embodiment, the validation item(s) which may be provided to server 120 may constitute all of the credential(s) for authentication, may constitute only a subset of the credential(s) for authentication, or may constitute more than all of the credential(s) for authentication. Depending on the embodiment, validation item(s) which may be provided to server 120, may be provided at the same time or at different phases (with latter phase(s) always occurring or only optionally occurring, for instance only optionally occurring if previously provided credentials were not accepted by the server 120).

As mentioned above, authentication may include provision of user credential(s) on one end, and acceptance of the credential(s) on the part of a server such as server 120 on the other end. If the user is authenticated (i.e. the credentials is/are accepted) then server 120 ma y allow access to the resource for which there is an authentication requirement. If the user is not authenticated (i.e. the credentials is/are not accepted), then server 120 may not allow access to the resource for which there is an authentication requirement. In accordance with the methods described herein, server 120 may receive one or more validation items from user system 110 and/or validation system 140 (e.g. validation confirmation or part thereof; captured audio, video and/or image data or a part thereof; indication that validation confirmation was generated or part thereof and/or other item(s) or a part thereof). At least one of the received item(s) may be assumed to be credential(s) acceptable to server 120. Therefore server 120 may allow access to the resource by client 114, at least partly based on this/these credential(s). For instance server 120 may allow access to the resource at least partly based on the validation confirmation or part thereof (e.g. at least partly based on a received validation confirmation or part thereof, and/or at least partly based on a received indication that a validation confirmation was generated, or a part thereof). It is noted that the decision by web server 120 to allow access may optionally also be based on other credential(s).

In the illustrated embodiments method 200 then ends.

In the illustrated embodiments, if instead (no to stage 228) no validation confirmation or part thereof was received (where confirmation or part thereof would have been expected to be received if confirmed), or if a warning of non-validation was received, then method 200 ends. In these embodiments and depending on the embodiment user system 110, for instance output 118, may or may not output to the user prior to method 200 ending, an indication of validation failure (e.g. indicating that no confirmation or part thereof was received, or indicating that a warning of non-validation was received). Alternatively to method 200 ending after no validation confirmation or part thereof was received when expected (or a warning of non-validation was received), in some embodiments, any of the previous stages of method 200 may be repeated in order to again attempt to enable validation system 140 to confirm user validation. In these embodiments, audio, video and/or image data newly captured during the repetition may relate to the same direction(s) as the previously captured data for which confirmation of validation failed or may relate different direction(s). In these embodiments, and depending on the embodiment, the previous stage(s) may be repeated a limited number of times, or an unlimited number of times in an attempt to enable validation system 140 to confirm validation.

Depending on the embodiment, no validation confirmation or part thereof may have been received when expected (or a warning of non-validation may have been received) for any reason such as insufficient quality and/or quantity of captured data, direction(s) not followed properly, another person pretending to be the user, and/or tampering unrelated to the user (e.g. man in the browser and/or other malware, man in the middle and/or other eavesdropping, etc), etc.

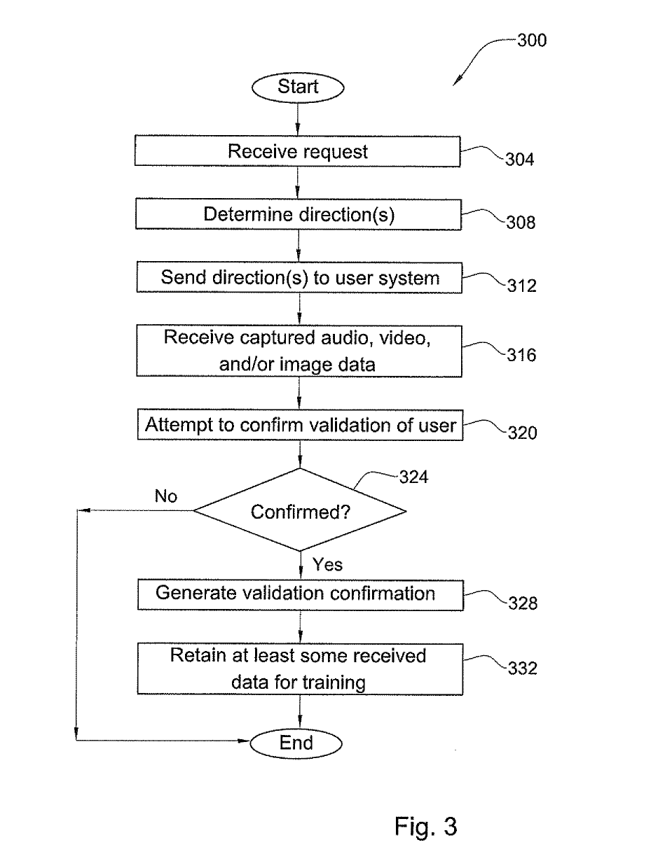

FIG. 3 is a flowchart illustration of a method 300 for online user authentication using audio, image and/or video data, according to some embodiments of the presently disclosed subject matter. In some cases, method 300 may be performed by validation system 140. In some cases, method 300 may include fewer, more and/or different stages than illustrated in FIG. 3, the stages may be executed in a different order than shown in FIG. 3, stages that are illustrated as being executed sequentially may be executed in parallel, and/or stages that are illustrated as being executed in parallel may be executed sequentially.

In the illustrated embodiments, in optional stage 304 validation system 140 receives a request for direction(s), from user system 110 or from server 120, via a channel in network 100 (e.g. channel 130). For instance, user system 110 or server 120 may have determined that there is an authentication requirement, for instance relating to a resource provided by server 120 which client 114 is attempting to access, and user system 110 or server 120 may have transmitted a request that validation system 140 provide direction(s) to user system 110. In some of these embodiments, stage 304 may be omitted, for instance because direction(s) may not be required to be provided to user system 110 prior to user system 110 capturing video, audio, and/or image data.

Depending on the embodiment, the transmitted request may or may not include data which validation system 140 may use in determining direction(s). For instance, included data may relate to the requirement for authentication. Continuing with this instance, if the requirement for authentication was detected for an online operation, secure message, and/or relating to a specific website, the data may include details on the online operation, secure message and/or website, respectively. Additionally or alternatively, for instance, included data may relate to the desired medium/media for capturing such as audio, video and/or image so that validation system 140 may provide direction(s) corresponding to the desired medium/media. Additionally or alternatively, for instance, included data may relate to the preferred language for audio and/or video capture so that validation system 140 may provide direction(s) corresponding to the preferred language.

In the illustrated embodiments, in optional stage 308, validation system 140, for instance director 146, determines the direction(s). In some of these embodiments, in order to determine direction(s), director 146 may generate data, retrieve data from memory 144, and/or modify what is retrieved from memory 144.

The disclosure does not impose limitations on the format and/or content of the direction(s). For instance, in some cases the format of the direction or part thereof may be appropriate for outputting to the user, for being received and/or modified by module(s) in user system 110 (e.g. validator 116), for providing direction(s) to module(s) in user system 110 (such as input 112), for being difficult when presented by user system 110 to be interpreted by machine, and/or for changing at user system 110 into a format appropriate for output to the user and/or for providing direction to module(s). Continuing with this instance if a direction or part thereof is to be output to the user, an appropriate format may in some cases allow the user to hear the direction(s), to view the direction(s), to hear part of the direction(s) and view a different part of the direction(s), to hear and view the direction(s), etc. Continuing with this instance, if a direction is to be provided to module(s) of user system 110, an appropriate format may in some cases include any format understandable by the module(s). Continuing with this instance, if a direction is to be received and/or modified by module(s) in user system 110, an appropriate format may in some cases include any format understandable by the module(s). Continuing with this instance, an appropriate format may in some cases include any format which is difficult when presented for a machine to interpret.

Although the disclosure does not impose limitations on the content of the direction(s), for the sake of further illustration to the reader, some examples are now provided which illustrate possible content of direction(s) relating to capturing audio, video, and/or image data of the user.

In one example, direction(s) may relate to initiating the capturing of video, audio and/or image data, stopping the capturing, and/or capture settings. Some cases of this example include direction(s) for starting/stopping capturing video by camera, capturing an image by camera, microphone turning on/off so as to capture/not capture sound, changing the camera setting(s) (e.g. zoom, focus zone, resolution, etc), etc. In some cases of this example, the direction(s) may include instruction(s) to the user to enable the image capturing, and/or to enable the beginning and/or ending of audio and/or video capturing (e.g., by pressing a button) whereas in other cases of this example, the direction(s) may additionally or alternatively include instruction(s) to module(s) of user system 110 to automatically capture image, audio and/or video data of the user, perhaps with user system 110 providing a countdown to the user so that the user can behave appropriately. In another example, direction(s) may additionally or alternatively include instruction(s) on how the user should speak and/or look (e.g. speak with no background noise, keep eyes open, etc). In another example, direction(s) may additionally or alternatively be at least partly based on data included in the request. For instance, in this example if the request included the desired medium/media, the direction(s) may relate to capturing data in the desired medium/media (e.g. audio, video and/or image). Additionally or alternatively for instance in this example if detail(s) on the authentication requirement were included in the request, one or more of the detail(s) may be included in the direction, perhaps in a text included in the direction(s). Additionally or alternatively, for instance in this example if the request included the preferred language, the direction(s) may correspond to the preferred language. In another example, the direction(s) may additionally or alternatively include instruction(s) that the user should speak while audio and/or video data is being captured, without necessarily specifying what the user should say. In another example, direction(s) may additionally or alternatively include what the user should say such as text(s) (each including one or more sounds, syllables, words, and/or sentences) which the user should say (e.g. read out loud) when audio and/or video data is being captured. In various cases of this example, included text(s) may be the same or different than previous text(s) that the user was requested to say. Additionally or alternatively, in some cases of this example, the content of a text may allow the user and/or validation system 140 to recognize if the text has been tampered with, whereas in other cases of this example the content of a text may not necessarily allow the user and/or validation system 140 to recognize that the text has been tampered with. For instance, a text may be supposed to include a correct reference to the requirement for authentication. Continuing with this instance and assuming the requirement for authentication related to transfer of funds, a text may be supposed to include the correct destination of the funds so that if the text was tampered with and the destination changed (e.g. by man in the browser and/or other malware, man in the middle and/or other eavesdropping, etc), the user may realize that there has been tampering and if desired take appropriate action. Additionally or alternatively, in some cases of this example, the content of a text may be randomly determined and may therefore be unlikely to be related to the authentication requirement (i.e. does not have to refer to the authentication requirement). In some of these cases, a random text may be less likely to be guessed at and included in a (fake) direction by a party pretending to be validation system 140 (than a text which was not randomly determined). In another example, the direction(s) may additionally or alternatively include direction(s) which may be presented in a manner that makes it difficult for a machine to interpret such as an image with skewed text which may be difficult for an optical recognition algorithm to interpret (e.g. CAPTCHA). In another example, the direction(s) may additionally or alternatively include direction(s) that an image of the user should be captured, without necessarily providing further specifics regarding the image. In another example, the direction(s) may additionally or alternatively specify gesture(s) and/or facial expression(s) that the user should make when the image is being captured (e.g. neither smile nor frown, show palm, etc). In another example, direction(s) may additionally or alternatively include direction(s) that a video of the user should be captured, without necessarily providing further specifics regarding the video. In another example, direction(s) may additionally or alternatively specify action(s) to be performed, what to say (e.g. text(s) to be said), gesture(s) and/or facial expression(s) to be made when the video is being captured (e.g. talk, say a certain text, first skip then shout and then stomp feet four times, raise eyebrows, show elbow, etc.).

Depending on the embodiment, validation system 140, for instance director 146, may or may not check in memory (e.g. memory 144) when determining the direction(s). For instance, if recognition is to be based on comparison of captured data with data stored in memory, then director 146 may check the data stored in memory when determining the direction(s) so that the direction may enable captured data to be recognized if the data should be recognized. Additionally or alternatively, for instance, if it is desirable to vary directions for validations of the same (assumed) user (i.e. for validations of who the user is claiming to be or to vary directions for any user validations, and past directions (for the same user or for any user) are stored in memory, then director 146 may check in memory when determining the direction(s) so as to ensure that the currently determined direction(s) may be different than a predetermined number of previously directions or any previous directions (for the same user or for any user). In this instance, the currently determined direction(s) may be for example generated and checked against previous directions to ensure difference(s), and/or, for example, previous directions stored in memory may be retrieved and modified in order to derive currently determined direction(s) which are different from previous directions.

In the illustrated embodiments, in optional stage 312, validation system 140, for instance director 140 transmits the direction(s) to user system 110 via a channel in network 100 (e.g. channel 130).

In some of these embodiments, stages 308 and 312 may be omitted, for instance if direction(s) may not need to be provided to user system 110. For instance, direction(s) may not need to be provided if standard and therefore already known to user system 110, if unnecessary because validation system 140 may be configured to perform recognition on any type of captured audio, video and/or image data, if direction(s) may be determined by user system 110 and transmitted to validation system 140 before validation system 140 performs recognition on captured audio, video and/or image data, and/or for any other reason.

In the illustrated embodiments, in stage 316, validation system 140, for instance recognizer 142 receives captured audio, video and/or image data from user system 110 via a channel in network 100 such as channel 130. Depending on the embodiment, the direction(s) associated with the received data may or may not also be received. The direction(s) may not be received, for instance, if previously sent in stage 312 or if unnecessary to know when performing recognition. The direction(s) for instance may be received, for instance because stage 312 was omitted and therefore validation system 140 did not send direction(s) but requires the direction(s) for recognition of the transmitted captured data, because user system 110 modified the direction(s) sent in stage 312 and validation system 140 requires the direction(s) for recognition of the transmitted captured data, in order to facilitate identification of the direction(s) sent in stage 312, in order to check that the direction(s) were not tampered with, and/or for any other reason. Optionally, validation system 140, for instance recognizer 142 may receive in addition to captured audio, video and/or image data other data which may assist in validating the user (e.g. user identifier and/or password, etc).

Depending on the embodiment, if direction(s) were received in stage 316 which should be the same as those sent in stage 312, the received direction(s) may or may not be checked against those sent. Received and sent directions which do not match may possibly indicate that the direction(s) may have been tampered with.

Depending on the embodiment, the received captured data may or may not be checked for recognition suitability. If the received captured data is considered not suitable for recognition, for instance due to poor quality or quantity, then in some cases validation system 140 may request that user system 110 again provide captured data. In some of these cases where the unsuitable captured data was associated with particular direction(s), the newly provided captured data may correspond to the same direction(s) or to different direction(s).

In the illustrated embodiments, in stage 320, validation system 140, for instance recognizer 142 attempts to confirm user validation (i.e. attempts to confirm the identity of the user, or in other words attempts to confirm that the user is who he/she is supposed to be). The attempt at least includes performing recognition on received captured data, since captured data may present a complete or partial proof of identity. The recognition may be performed on all of the received captured data or only part of the received captured data. The recognition performed may be any type of recognition such as including speech, speaker, image and/or video recognition, as appropriate for the captured data.

In some of these embodiments, during the recognition performed in the confirmation attempt, recognizer 142 may compare received captured data to corresponding direction(s) to see if captured data corresponds with sufficient probability to the content of the corresponding direction(s). The direction(s) for instance, may be standard, may have been received in stage 316 and/or may be retrieved from memory 144 after having been sent to user system 110 in stage 312. For instance, if the corresponding direction(s) includes a text, it may be checked whether or not captured data includes with sufficient probability the saying of the same text. Additionally or alternatively, if the direction(s) includes specification of action(s), gesture(s), and/or facial expression(s), it may be checked whether or not captured data includes with sufficient probability the specified action(s), gesture(s), and/or facial expression(s), etc included. In some cases, if the said text(s), action(s), gesture(s), facial expression(s), etc included in captured data do not match the direction(s) with sufficient probability, it may possibly be an indication that the direction(s) and/or captured data has been tampered with (e.g. by a person pretending to be the user where audio, video and/or image data was captured of that person instead, by man in the browser and/or other malware, by man in the middle and/or other eavesdropping, etc). For instance, in some of these cases, a text included in the direction(s) may have included a correct reference to the requirement for authentication. Continuing with this instance and assuming the requirement for authentication related to transfer of funds, a text included in the direction(s) may have included the correct destination of the funds. Therefore, the said text is also supposed to refer to the correct destination. In this instance, if there is insufficient probability that the said text included in captured data refers to the correct destination, it is possible that the text and/or captured data had been changed (e.g. by man in the browser and/or other malware, man in the middle and/or other eavesdropping, etc). Additionally or alternatively, for instance, in some of these cases, if the said text(s), action(s), gesture(s), facial expression(s) included in captured data etc do not match the direction(s) with sufficient probability, it may be an indication that the captured data was captured in the past (e.g. relating to other direction(s)) and was currently sent to validation system 140 without user knowledge (e.g. by man in the browser and/or other malware, man in the middle and/or other eavesdropping, etc.).

In some of these embodiments, additionally or alternatively where memory (e.g. memory 144) includes personal data associated with whom the user is claiming to be, during the recognition performed during the confirmation attempt, recognizer 142 may compare the captured data to see if the captured data matches with sufficient probability the stored personal data associated with whom the user is claiming to be. For instance, it may be checked whether or not the personal appearance captured in image and/or video data unit(s) matches with sufficient probability any of the stored image(s) of whom the user is claiming to be, whether or not the voice captured in audio and/or video data unit(s) matches with sufficient probability any of the stored voice sample(s) of whom the user is claiming to be, etc.

The disclosure does not limit the meaning of the term sufficient probability with respect to recognition, and depending on the embodiment, different probability levels may be considered sufficient.

In some embodiments, the attempt in stage 320 to confirm user validation may optionally also rely on other data (e.g. user identifier and/or password), for instance received from user system 110. Additionally or alternatively, the attempt in stage 320 to confirm user validation may optionally also include other (non-recognition) operation(s).

In the illustrated embodiments, in stage 324, validation system 140, for instance recognizer 142, determines whether or not the attempt of stage 320 to confirm validation of the user has succeeded or failed (i.e. whether or not the identity of the user is confirmed). If the validation attempt succeeded (i.e. confirmed—yes to stage 324) then in the illustrated embodiments, in stage 328, validation system 140, for instance recognizer 142 generates a validation confirmation.

Optionally, validation system 140, for instance recognizer 142 may provide the validation confirmation or a part thereof to user system 110 and/or to server 120. Optionally, validation system 140, for instance recognizer 142 may additionally or alternatively internally store (e.g. in memory 144) an indication that a validation confirmation was generated and may provide an indication of validation confirmation generation or a part thereof to server 120. Optionally, validation system 140 may additionally or alternatively provide at least some of the received captured data and/or received other data (e.g. user identifier and/or password) to server 120. See above description of method 200 for more details.

In the illustrated embodiments, in optional stage 332, validation system 140, for instance recognizer 142, uses at least some of the received captured data for training purposes. For instance, if personal data is stored in memory 144, then after the identity of the user has been confirmed the newly received captured data on the user may be used to enhance the collection of personal data on the user so that subsequently received captured data supposedly relating to the user may also be compared to previously received and saved captured data. Additionally or alternatively, for instance, the received captured data may be used to update non-personalized recognition techniques, such as improving the recognition of syllables, words, gestures, facial expressions, actions, etc. In some of these embodiments, stage 332 may be omitted for any reason, for instance because training is no longer necessary, because the received captured data is not suitable for training, etc. Method 300 then ends.

If instead, the attempt at validation confirmation failed (no to stage 324) then in the illustrated embodiments, method 300 ends. It is noted that the failure to confirm validation may not necessarily indicate that another person is pretending to be the user and audio, video, and/or image data was captured of that person instead. For instance, in some cases, the quality and/or quantity of received captured data may be insufficient to confirm validity. Additionally or alternatively, the failure may arise from tampering unrelated to another person pretending to be the user (e.g. man in the browser and/or other malware, man in the middle and/or other eavesdropping, etc.). Additionally or alternatively the failure may arise from direction(s) not having been followed properly. Optionally prior to method 300 ending, validation system 140 may provide a warning of non-validation of the user to user system 110 and/or to server 120. Alternatively to method 300 ending if validation of the user is not confirmed, in some embodiments, any of the previous stages of method 300 may be repeated in order to again attempt to confirm validation. In these embodiments, audio, video and/or image data which undergoes recognition during the repetition may relate to the same direction(s) as the data for which the attempt at validation confirmation failed or may relate to different direction(s). In these embodiments, and depending on the embodiment, the previous stage(s) may be repeated a limited number of times, or an unlimited number of times in an attempt to confirm validation.

It will also be understood that in some embodiments a system or part of a system according to the presently disclosed subject matter may be a suitably programmed machine. Likewise, some embodiments of the presently disclosed subject matter contemplate a computer program being readable by a machine for executing a method of the presently disclosed subject matter. Some embodiments of the presently disclosed subject matter further contemplate a machine-useable medium tangibly embodying program code readable by the machine for executing a method of the presently disclosed subject matter.

While the presently disclosed subject matter has been shown and described with respect to particular embodiments, it is not thus limited. Numerous modifications, changes and improvements within the scope of the presently disclosed subject matter will now occur to the reader.

1. A system for online user authentication using audio, video and/or image data, comprising:
a client operable to attempt to gain access to a resource provided by a server for which there is a requirement for authentication of a user of said client;
an input operable to capture audio, video and/or image data of said user; and
a validator operable to transmit at least part of said captured audio, video and/or image data to a validation system, thereby enabling said validation system to generate a validation confirmation if identity of said user is confirmed at least partly based on at least part of said transmitted data.

2. The system of claim 1, wherein said system is further operable to receive at least part of said validation confirmation from said validation system, and to transmit at least part of said validation confirmation to said server.

3. The system of claim 1, wherein said system is further operable to transmit at least part of said captured data to said server during authentication.

4. The system of claim 1, wherein said captured data includes audio and/or video data captured while said user says a text.

5. The system of claim 4, wherein said text and said captured data are supposed to refer correctly to said authentication requirement so that if said text or said captured data does not refer correctly to said requirement, then it is possible that said text or said captured data has been tampered with.

6. The system of claim 4, wherein said text does not have to refer to said authentication requirement.

7. The system of claim 1, wherein said system is further operable to receive at least one direction relating to capturing audio, video and/or image data of said user from said validation system.

8. The system of claim 1, wherein said captured data includes at least one of the following captured for said user: an action, a gesture, or a facial expression.

9. The system of claim 1, wherein said client is a web browser or other application operable to attempt to access a resource provided by a web server, and wherein said server is a web server.

10. The system of claim 1, wherein said validator is included in said client.

11. The system of claim 1, wherein said validator is external to said client.

12. The system of claim 1, further comprising, a validation system operable to generate a validation confirmation if identity of said user is confirmed to be proven at least partly based on at least part of said transmitted data.

13. The system of claim 1, further comprising: a server operable to allow access to said resource at least partly based on said validation confirmation or a part thereof.

14. The system of claim 1, being at least one user device, and if necessary further comprising additional hardware, software, firmware or a combination thereof which enables said system to perform any additional functionality associated with said at least one device.

15. The system of claim 1, being at least one element which services multiple user devices, and if necessary further comprising additional hardware, software, firmware or a combination thereof which enables said system to perform any additional functionality associated with said at least one element.

16. The system of claim 1, further comprising an output operable to output at least one direction relating to capturing audio, video and/or image data of said user.

17. The system of claim 16, wherein said output is independent of a user device associated with said input.

18. The system of claim 17, wherein said output is associated with a device operable to receive a message.

19. The system of claim 16, wherein said output is associated with a user device which is also associated with said input.

20. The system of claim 1, further operable to determine that there is said authentication requirement.

21. A validation system for online user authentication using audio, video and/or image data, comprising:
a recognizer operable to receive audio, video, and/or image data captured by a user system,
operable to attempt to confirm identity of a user of said user system, including operable to perform recognition on at least part of said received data, and
operable, if confirmed, to generate a validation confirmation, thereby enabling a server to allow access, at least partly based on said validation confirmation or a part thereof, to a resource provided by said server which requires authentication of said user.

22. The system of claim 21, further comprising: a director operable to determine at least one direction to be provided to said user system relating to capturing of audio, video and/or image data.

23. The system of claim 22, wherein said at least one direction includes a text which is supposed to correctly refer to said authentication requirement so that if said text, or audio and/or video data captured while said user says a text, does not correctly refer to said authentication requirement, then it is possible that said text or said captured audio and/or video data has been tampered with.

24. The system of claim 22, wherein said at least one direction includes text which does not have to refer to said authentication requirement.

25. The system of claim 21, wherein said recognizer being operable to perform recognition includes: being operable to compare at least part of said received data to at least one direction relating to capturing of audio, video and/or image data.

26. The system of claim 21, wherein said recognizer being operable to perform recognition includes: being operable to compare at least part of said received data to stored personal data associated with whom said user is claiming to be.

27. The system of claim 21, wherein said server is a web server.

28. The system of claim 21, wherein at least part of said system is included in said server.

29. The system of claim 21, wherein said system is not included in said server.

30. The system of claim 21, further operable to provide said confirmation or a part thereof to at least one of said user system or server.

31. The system of claim 21, further operable to provide at least part of said received data to said server during authentication.

32. A server, operable to allow access to a resource which requires user authentication at least partly based on a validation confirmation or a part thereof, wherein said validation confirmation was generated after identity of a user of a user system was confirmed at least partly based on at least part of audio, video, and/or image data captured by said user system.

33. The server of claim 32, being a web server.

34. The server of claim 32, further operable to receive at least part of said captured data.

35. A method of online user authentication using audio, video and/or image data, comprising:
capturing audio, video and/or image data of said user; and
transmitting at least part of said captured data to a validation system, thereby enabling said validation system to generate a validation confirmation if identity of said user is confirmed at least partly based on at least part of said transmitted data.

36. The method of claim 35, further comprising: receiving or determining at least one direction relating to capturing audio, video and/or image data of said user.

37. The method of claim 36, wherein said at least one direction includes at least one selected from a group comprising: direction relating to initiating the capturing of video, audio and/or image data, direction relating to stopping the capturing, direction relating to capture settings, direction relating to how user should speak, direction relating to what user should say, direction relating to how user should look, direction relating to desired medium, direction corresponding to desired language, direction relating to authentication requirement, direction relating to user speaking, direction relating to a text which user should say, direction which when presented is difficult for a machine to interpret, direction relating to capturing image, direction relating to gesture user should make, direction relating to facial expression that user should make, or direction relating to action that user should perform.

38. The method of claim 35, further comprising: outputting at least one direction to said user relating to capturing audio, video and/or image data.

39. The method of claim 35, further comprising: requesting direction from said validation system relating to capturing audio, video and/or image data of said user.

40. The method of claim 35, further comprising: receiving at least part of said validation confirmation from said validation system, and transmitting at least part of said validation confirmation to said server.

41. The method of claim 35, further comprising: generating a validation confirmation if identity of said user is confirmed at least partly based on at least part of said transmitted data.

42. The method of claim 35, further comprising: allowing access to said resource at least partly based on said validation confirmation or a part thereof.

43. The method of claim 35, further comprising: determining that there is said authentication requirement.

44. The method of claim 35, further comprising: transmitting at least part of said captured data to said server.

45. The method of claim 35, wherein said server is a web server.

46. A method of online user authentication using audio, video and/or image data, comprising:
receiving audio, video, and/or image data captured by a user system;
attempting to confirm identity of a user of said user system, including: performing recognition on at least part of said received data; and if confirmed, generating a validation confirmation, thereby enabling a server to allow access, at least partly based on said validation confirmation or a part thereof, to a resource provided by said server which requires authentication of said user.

47. The method of claim 46, further comprising: determining at least one direction to be provided to said user system relating to capturing of audio, video and/or image data.

48. The method of claim 46, further comprising: receiving a request for direction relating to capturing audio, video and/or image data.

49. The method of claim 46, further comprising: providing at least part of said received data to said server.

50. The method of claim 46, wherein said server is a web server.

51. A method of online user authentication using audio, video and/or image data, comprising:
allowing access to a resource which requires user authentication at least partly based on a validation confirmation or a part thereof, wherein said validation confirmation was generated after identity of a user of a user system was confirmed at least partly based on at least part of audio, video, and/or image data captured by said user system.

52. The method of claim 51, wherein said method is performed by a web server.

53. A computer program product comprising a computer useable medium having computer readable program code embodied therein for online user authentication using audio, video and/or image data, the computer program product comprising:
computer readable program code for causing the computer to capture audio, video and/or image data of said user; and
computer readable program code for causing the computer to transmit at least part of said captured data to a validation system, thereby enabling said validation system to generate a validation confirmation if identity of said user is confirmed at least partly based on at least part of said transmitted data.

54. A computer program product comprising a computer useable medium having computer readable program code embodied therein for online user authentication using audio, video and/or image data, the computer program product comprising:
computer readable program code for causing the computer to receive audio, video, and/or image data captured by a user system;
computer readable program code for causing the computer to attempt to confirm identity of a user of said user system, including: computer readable program code for causing the computer to perform recognition on at least part of said received data; and
computer readable program code for causing the computer to generate a validation confirmation if confirmed, thereby enabling a server to allow access, at least partly based on said validation confirmation or a part thereof, to a resource provided by said server which requires authentication of said user.

55. A computer program product comprising a computer useable medium having computer readable program code embodied therein for online user authentication using audio, video and/or image data, the computer program product comprising:
computer readable program code for causing the computer to allow access to a resource which requires user authentication at least partly based on a validation confirmation or a part thereof, wherein said validation confirmation was generated after identity of a user of a user system was confirmed at least partly based on at least part of audio, video, and/or image data captured by said user system.
